(19) United States
(12) Patent Application Publication
(10) Pub. No.: US 2015/0262380 A1
(43) Pub. Date: Sep. 17, 2015

(54) ADAPTIVE RESOLUTION IN OPTICAL FLOW COMPUTATIONS FOR AN IMAGE PROCESSING SYSTEM

(71) Applicant: QUALCOMM INCORPORATED, San Diego, CA (US)

(72) Inventors: Philipp Grasmug, Graz (AT); Dieter Schmalstieg, Graz (AT); Stefan Hauswiesner, Puch (AT); Denis Kalkofen, Graz (AT)

(21) Appl. No.: 14/658,108

(22) Filed: Mar. 13, 2015

Related U.S. Application Data
(60) Provisional application No. 61/954,431, filed on Mar. 17, 2014.

(51) Int. Cl. G06T 7/20; G06T 19/00

(52) U.S. Cl. CPC G06T 7/2073; G06T 7/2093; G06T 19/006; G06T 2207/10016; G06T 2207/30244; G06T 2207/20016; G06T 2207/20004

(57) ABSTRACT

A method, device, and apparatus for determining optical flow from a plurality of images is described and includes receiving a first image frame from a first plurality of images, where the first plurality of images have a first resolution and a first frame rate. A second image frame may be received from a second plurality of images, where the second plurality of images have a second resolution less than the first resolution and a second frame rate greater than the first frame rate. A first optical flow may be computed from the first image frame to the second image frame. Additionally, the based at least in part on the first optical flow from the first image frame to the second image frame, a third image frame may be output as part of an output stream. The output stream may have a frame rate greater than or equal to the first frame rate, where the third image frame has a resolution greater than or equal to the second resolution.

### CROSS-REFERENCE TO RELATED APPLICATION

This application claims the benefit of U.S. Provisional Application No. 61/954,431, filed Mar. 17, 2014.

### TECHNICAL FIELD

This disclosure relates generally to computer vision based object recognition applications, and in particular but not exclusively, relates to computing optical flow in an image processing system.

### BACKGROUND INFORMATION

A wide range of electronic devices, including mobile wireless communication devices, personal digital assistants (PDAs), laptop computers, desktop computers, digital cameras, digital recording devices, and the like, may employ machine/computer vision techniques to provide versatile imaging capabilities. For example, some machine vision techniques assist users in recognizing landmarks, identifying particular persons, provide augmented reality (AR) applications, and a variety of other tasks.

Motion tracking of objects, or environments from one image frame to another may be leveraged by one or more machine vision techniques such as those introduced above. For example, AR systems may be used to identify motion of one or more objects within an image and provide users with a representation of the one or more objects on a display. AR systems attempt to reconstruct both the time-varying shape and the motion for each point on a reconstructed surface, typically utilizing tools such as three-dimensional (3-D) reconstruction and image-based tracking via optical flow. In contrast to attempting to recognize an object from image pixel data and then tracking the motion of the object among a sequence of image frames, optical flow instead tracks the motion of features from image pixel data.

Optical flow may also be used for tasks other than computer vision, such as video compression. However, as in computer vision implementations, mobile platforms may be unable to fully utilize optical flow due to computational requirements and limitations of particular input image feeds. For example, when computing optical flow on video with a low frame rate, the displacement between any two frames may be high, resulting in errors or failure computing optical flow. Therefore, improved techniques relating to optical flow is desirable.

### BRIEF SUMMARY

Embodiments disclosed herein may relate to a method for determining optical flow from a plurality of images and may include receiving a first image frame from a first plurality of images, where the first plurality of images have a first resolution and a first frame rate. The method may also include receiving a second image frame from a second plurality of images, where the second plurality of images have a second resolution less than the first resolution and a second frame rate greater than the first frame rate. The method may also include computing a first optical flow from the first image frame to the second image frame. Additionally, the method may also include outputting, based at least in part on the first optical flow from the first image frame to the second image frame, a third image frame as part of an output stream, the output stream having a frame rate greater than or equal to the first frame rate, where the third image frame has a resolution greater than or equal to the second resolution.

Embodiments disclosed herein may further relate to a device to determine optical flow from a plurality of images. The device may include instructions to receive a first image frame from a first plurality of images, where the first plurality of images have a first resolution and a first frame rate and receive a second image frame from a second plurality of images, where the second plurality of images have a second resolution less than the first resolution and a second frame rate greater than the first frame rate. The device may also include instructions to compute a first optical flow from the first image frame to the second image frame. Additionally, the device may also include instructions to output, based at least in part on the first optical flow from the first image frame to the second image frame, a third image frame as part of an output stream, the output stream having a frame rate greater than or equal to the first frame rate, where the third image frame has a resolution greater than or equal to the second resolution.

Embodiments disclosed herein may also relate to an apparatus with means for determining optical flow from a plurality of images includes receiving a first image frame from a first plurality of images, where the first plurality of images have a first resolution and a first frame rate. The method may also include receiving a second image frame from a second plurality of images, where the second plurality of images have a second resolution less than the first resolution and a second frame rate greater than the first frame rate. The method may also include computing a first optical flow from the first image frame to the second image frame. Additionally, the method may also include outputting, based at least in part on the first optical flow from the first image frame to the second image frame, a third image frame as part of an output stream, the output stream having a frame rate greater than or equal to the first frame rate, where the third image frame has a resolution greater than or equal to the second resolution.

Embodiments disclosed herein may further relate to an article comprising a non-transitory storage medium with instructions that are executable to perform optical flow from a plurality of images. The medium may include instructions to receive a first image frame from a first plurality of images, where the first plurality of images have a first resolution and a first frame rate and receive a second image frame from a second plurality of images, where the second plurality of images have a second resolution less than the first resolution and a second frame rate greater than the first frame rate. The medium may also include instructions to compute a first optical flow from the first image frame to the second image frame. Additionally, the medium may also include instructions to output, based at least in part on the first optical flow from the first image frame to the second image frame, a third image frame as part of an output stream, the output stream having a frame rate greater than or equal to the first frame rate, where the third image frame has a resolution greater than or equal to the second resolution.

The above and other aspects, objects, and features of the present disclosure will become apparent from the following description of various embodiments, given in conjunction with the accompanying drawings.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 is a diagram illustrating the timing of frames for use as input with Multi-Resolution Optical Flow (MROF), in one embodiment.

FIG. 2 is a flowchart illustrating a process for performing MROF, in one embodiment.

FIG. 3 is a flowchart illustrating a process for performing MROF, in another embodiment.

FIG. 4 is a functional block diagram of a processing unit capable of performing MROF, in one embodiment.

FIG. 5 is a functional block diagram of an exemplary mobile platform capable of performing the MROF as discussed herein.

FIG. 6 is a functional block diagram of an exemplary image processing system capable of performing the processes discussed herein.

### DETAILED DESCRIPTION

Reference throughout this specification to “one embodiment,” “an embodiment,” “one example,” or “an example” means that a particular feature, structure, or characteristic described in connection with the embodiment or example is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. Any example or embodiment described herein is not to be construed as preferred or advantageous over other examples or embodiments.

Typical optical flow implementations, especially in lower power environments such as mobile platforms or devices, are optimized for a constant frame rate, low-resolution image stream. For example, the computation of optical flow in a mobile platform may be limited to available resources such as a high-resolution (but bandwidth limited) camera, a SLAM system for camera tracking, and generation of a sparse point cloud, and a graphics processing unit (GPU) with rasterization, texturing, and shading. Because there may be large displacement (e.g., change in camera position and orientation) between successive image frames in a low frame rate (e.g., high-resolution) image stream, errors may occur during the optical flow computation. Alternatively, a low-resolution image stream may have a high frame rate, but low data density within each image frame resulting in a low-resolution output from optical flow.

As described herein, Multi-Resolution Optical Flow (referred to herein simply as “MROF”) computes optical flow from combinations of low or high-resolution input images. MROF can also compute optical flow from combinations of low and high frame rate streams (e.g., video feeds or other image sets). For example, MROF may receive a high-resolution input followed by a low-resolution input and can determine optical flow from the two images of different resolution. MROF can continue to determine optical flow between low-resolution image frames at a high frame rate until a next high-resolution image is received. When the most recent high-resolution image is received, MROF can determine optical flow between the most recent low-resolution image and the most recent high-resolution image. In one embodiment, MROF provides an output image stream or video with resolution as high as the resolution of the high-resolution input at the frame rate as fast as the frame rate of the low-resolution input.

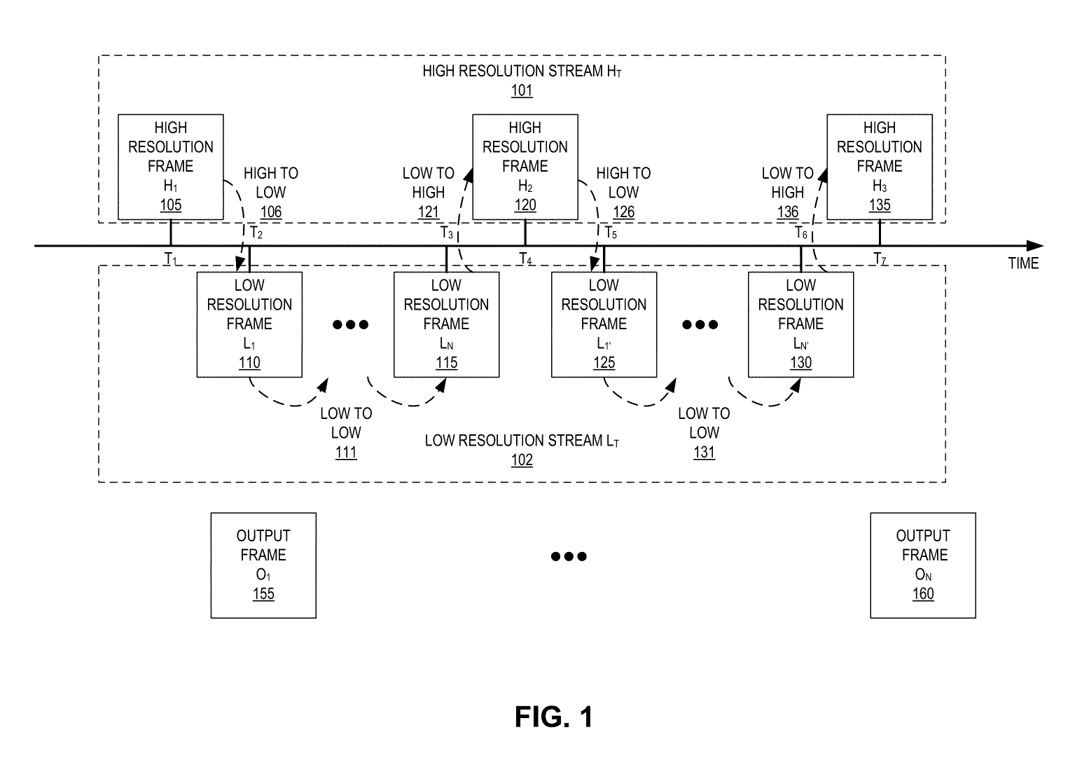

FIG. 1 is a diagram illustrating the timing of optical flows between frames of different resolutions, in one embodiment. FIG. 1 illustrates two image streams or sources. In one embodiment, a first image source provides a high-resolution stream H_{T} and a second image source provides a low-resolution stream L_{T}. For example, the first image source may be from a high-resolution camera sensor, while the second image source may be a low-resolution camera sensor. In other embodiments, the high-resolution stream H_{T} and low-resolution stream L_{T} may originate from the same camera source. For example, instead of two different cameras, a mobile platform may include one camera sensor capable of providing different resolution output, such as a low-resolution video stream and high-resolution still images.

As illustrated in FIG. 1, the high-resolution frames may occur (e.g., generated, received, or otherwise obtained by the mobile platform) at a lower interval or frequency than the low-resolution frames. For example, high-resolution frames H_{T} 101 may be less frequent due to processing or bandwidth limitations.

In one embodiment, MROF can compute optical flow between different resolution image frames (e.g., high to low such as 106 and 126, or low to high such as 121 and 136). Flexibility in image resolution processing provides for efficient processing on a mobile platform by using less processor intensive low-resolution frames in between high-resolution frames.

As illustrated in FIG. 1, MROF may output image frames O₁ 155 through O_{N} 160 based at least in part on respective optical flow computations. For example, O₁ may be the resulting output from the first high to low 106 optical flow computation between a first (low resolution frame H₁ 105) and second image frames (low resolution frame L₁ 110). Output frames may occur shortly after the receipt of the second frame within an image pair. For example, optical flow high to low 106 may occur at T₂ and output frame O1 155 may be output or displayed at T_{2+optical flow processing time t}.

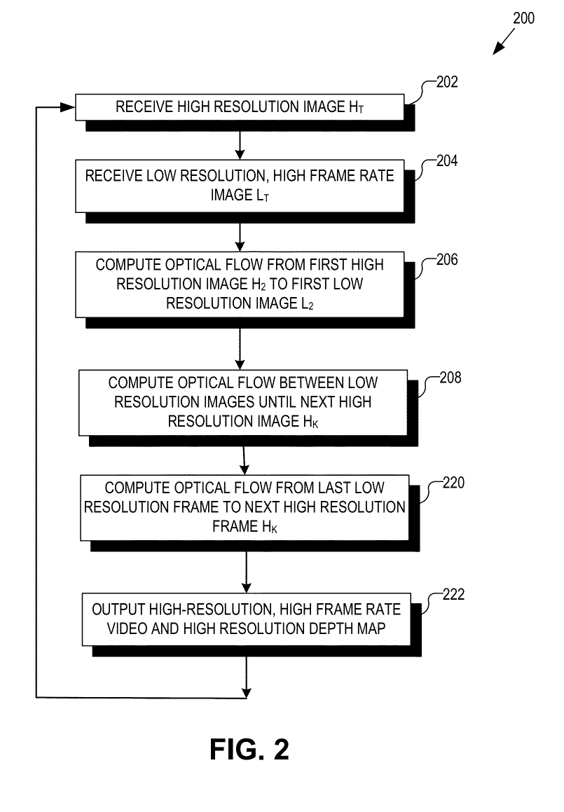

FIG. 2 is a flowchart illustrating a process for performing MROF, in one embodiment. MROF can combine multiple streams with different resolution and frame rates to output another stream with high-resolution (e.g., resolution of high-resolution stream H_{T}) and high frame rate (e.g., frame rate of low-resolution stream L_{T}). MROF can register a high-resolution image frame (e.g., a most recently received high-resolution image frame) to a current low-resolution image frame. At block 202 high-resolution, low frame rate video H_{T} is received. In one embodiment, the high-resolution stream H_{T} includes several high-resolution frames from H₁ to H_{K}. Frames H₁ to H_{K} may also be referred to as keyframes, or trigger frames used to initialize optical flow from low-resolution to high-resolution image frames.

At block 204, a low-resolution image is received from a high frame rate stream. In one embodiment, the low-resolution image is received from a high frame rate camera source. In other embodiments, the low-resolution image is down sampled from a high-resolution image source, for example, the high-resolution image source may be the high-resolution, and therefore does not include any down sampling of the high-resolution stream. For example, the low-resolution stream may be received directly from a video source, such as a camera (e.g., camera 502).

In one embodiment, image frames from the high-resolution image stream is down sampled into a low-resolution image stream for use as high frame rate video L_{T}. Blocks 206 through 210 then illustrate the computation of optical flow from the first high-resolution frame H₁ through the low-resolution frames and on to the next high-resolution keyframes.

At block 206, the embodiment (e.g., MROF) computes the optical flow between a first (e.g., at time T₁) high-resolution frame (e.g., H₁ 105) and a first (e.g., at time T₂) low-resolution frame (e.g., L₁ 110). In some embodiments, MROF will select an optical flow processing method with a balance between speed and quality. For example, if the computation of the optical flow takes too long it may negatively impact the frame rate of the output stream. In one embodiment, the optical flow computation is a global optimal one to handle homogeneous regions better and give more stable results if the flow is computed in in both directions. For example, local of algorithms may have more ambiguity due to missing constraints.

At process block 208, optical flows are computed between low-resolution frames (e.g., L₁ 110 to L_{N} 115) until the next (e.g., at time T₄) high-resolution frame (e.g., H₂ 120) is received. In one embodiment, the of low-resolution frames (e.g., number “N” illustrated in FIG. 1) is variable for each computation of optical flow between successive high-resolution frames. For example, depending on the resources available and/or the availability of images from the respective camera sensor, a mobile platform may not be ready or yet able to compute optical flow with a high-resolution frame. Thus, embodiments of the present disclosure allow for the continued computation of optical flow using a lower resolution, high frame rate image source until the next high-resolution (e.g., higher than the low-resolution) computation is feasible. For example, some mobile platforms may provide for a low-resolution video stream or feed, while concurrently allowing for a high-resolution still image to be captured at the maximum sensor resolution. As used herein, what defines a low-resolution streams varies depending on the state of the art. As an illustrative numerical example, a low-resolution stream may be 640×480 pixels, 3840×2160 pixels, or some other resolution as is available from the particular camera sensor compared to a high-resolution (e.g., higher than the low-resolution) image of 6016×4016 or some other resolution greater than the low-resolution stream.

Next, in process block 210, the optical flow is computed from the last low-resolution frame (e.g., L_{N} 115) to the next high-resolution frame (e.g., H₂ 120). Accordingly, optical flow computations may be made between low-resolution images (e.g., L₁ 110 and L_{N} 115) until the next high-resolution frame is received. As mentioned above, computing the optical flow between frames of the low-resolution, high-frame rate video includes computing the optical flow between “N” number of frames of the low-resolution video between consecutive frames of the high-resolution, low frame rate video. However, the number “N” may be variable, based, for example, on the resources available to a mobile platform. Thus, embodiments of the present disclosure allow for a variable resolution in the computation of optical flow, wherein the number N of low-resolution frames varies between consecutive frames of the high-resolution video.

In one embodiment, after the optical flow is computed, each pixel of the high-resolution image frame may be moved according to the displacement vectors of the flow field. The output image frame will then resemble the current view of the camera but in the high-resolution of the image stream. The optical flow may be computed between low-resolution image frames until a next available high-resolution image frame is received.

In one embodiment, optical flow is initialized with the result from one or more previous computations. For example, disparity between two image frames may be high, and may produce errors in typical optical flow computations. However, MROF can initialize with the flow field from a previous computation to guide the optical flow algorithm in the right direction. For example, the previous computation may offer data as a prior where to look for a particular corresponding pixel.

Returning now to FIG. 2, process block 212 includes the outputting of a high-resolution, high frame rate video and an optional high-resolution depth map. In one embodiment, the resolution of the outputted video is higher than the resolution of the low-resolution stream L_{T} and the frame rate of the outputted video is higher than the low frame rate of the stream H_{T}. Process 200 then repeats, as shown in FIG. 2.

As will be described below, embodiments of the present disclosure may be implemented in a mobile platform where resources, such as processor clocks, are limited. In some examples, a camera included in such a mobile platform may have a maximum resolution at a certain frame rate. Process 200 described above may allow the mobile platform to capture and output images at a higher spatial resolution for a given temporal resolution. In some embodiments, the highest achievable spatial resolution may be dependent on the camera output resolution and/or the processing power of the device.

In certain cases, optical flow computation may fail. For example, if an object is visible in one image frame but gone/occluded in a next image frame the flow computation may yield erroneous results. Using optical flow in such error prone regions to displace pixels of the high-resolution image may introduce visible artifacts into the output result. In one embodiment, MROF determines optical flow from a first frame to a second frame should be equivalent to the optical flow from the second frame to the first frame except for an inverted sign. MROF can generate a confidence map using the sign data to determine reliability of a particular optical flow, such as in the example equation 1 below.

$$confidence = 1 - λ ( \frac{\vert {uv}_{forward} ( p ) + {uv}_{backward} ( p + {uv}_{forward} ( p ) ) \vert}{α} ) . \qquad EQ 1$$

In response to determining the reliability of the optical flow, MROF can blend the morphed high-resolution image with an up sampled version of the current image frame according to the confidence map. For example, MROF may initiate or perform blending of a morphed current (high-resolution) image frame with an up sampled version of the previous image frame in response to determining an optical flow computation from the previous image frame to a current image frame is unreliable.

Therefore, MROF can filter out optical flow error artifacts from occurring in the output stream. For example, the confidence map may provide reliability data per pixel for the optical flow computation of a particular pair of image frames. For example, within the confidence map a value of 1 may indicate the data as being entirely reliable and a value of 0 may indicate the data is unreliable (e.g., erroneous, invalid, or untrustworthy), with a potentially infinite number of values in-between the two aforementioned extremes. In one embodiment, a high-resolution and up sampled low-resolution are blended pixel wise according to the confidence map. Therefore, if a particular optical flow computation failed (e.g. in a homogenous region) MROF may revert to the up sampled low-resolution image frame to avoid introducing artifacts.

In another embodiment, MROF can leverage a tracking system (e.g., simultaneous localization and mapping or marker tracking) to provide depth estimation from the output optical flow. For example, the optical flow field provides where each pixel has a corresponding pixel in another frame, therefore a per pixel depth map can be computed by triangulation using the camera pose information from the tracking system.

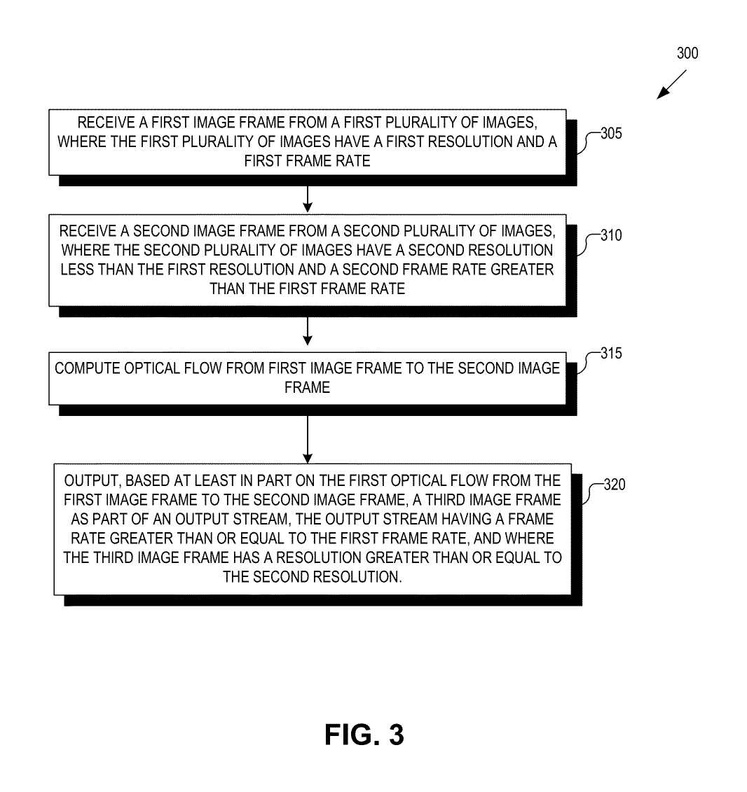

FIG. 3 is a flowchart illustrating a process 300 for multi-resolution optical flow computation, in another embodiment. As introduced above MROF computes optical flow on image frames from a lower resolution stream to reduce computational complexity of optical flow. In one embodiment, when a high-resolution image frame is received, the optical flow computation is performed with that high-resolution image (e.g., from low to high). MROF therefore allows for creation of high-resolution and high frame rate output video with reduced computational effort. The variation of the number of low-resolution frames in the process depends on the available resources, such as camera and platform/device performance. With regards to FIG. 3, at block 305, the embodiment (e.g., MROF) receives a first image frame from a first plurality of images having a first resolution, the first plurality of images having a first resolution and a first frame rate.

At block 310, the embodiment receives a second image frame from a second plurality of images, the second plurality of images having a second resolution less than the first resolution and a second frame rate. In some embodiments, the first plurality of images (i.e., high-resolution images, low frame rate) are received from a first camera sensor, and the second plurality of images (i.e., low-resolution, high frame rate) are received from a second (i.e., different or separate) camera sensor. In other embodiments, the first plurality of images and the second plurality of images are received from a same camera sensor.

At block 315, the embodiment computes optical flow from the first image frame to the second image frame. In some embodiments, if a high-resolution frame arrives at the same time as a low-resolution frame, MSOF can directly use the high-resolution frame without computing the registration.

At block 320, the embodiment outputs, based at least in part on the first optical flow from the first image frame to the second image frame, a third image frame as part of an output stream, the output stream having a frame rate greater than or equal to the first frame rate, and the third image frame has a resolution greater than or equal to the second resolution. In one embodiment, the first plurality of images comprise a first frame rate, the second plurality of images comprise a second frame rate greater than the first frame rate, and the third image frame is one of a third plurality of images output with a frame rate greater than the first frame rate. In some embodiments, MROF outputs a depth map at the third resolution in response to the computed optical flows. For the depth estimation MSOF may keep the latest “N” input image frames in memory or some equivalent storage. This allows MSOF to select two frames for the triangulation with a certain baseline. For example, MSOF can use the camera pose from the tracking system to estimate the baseline.

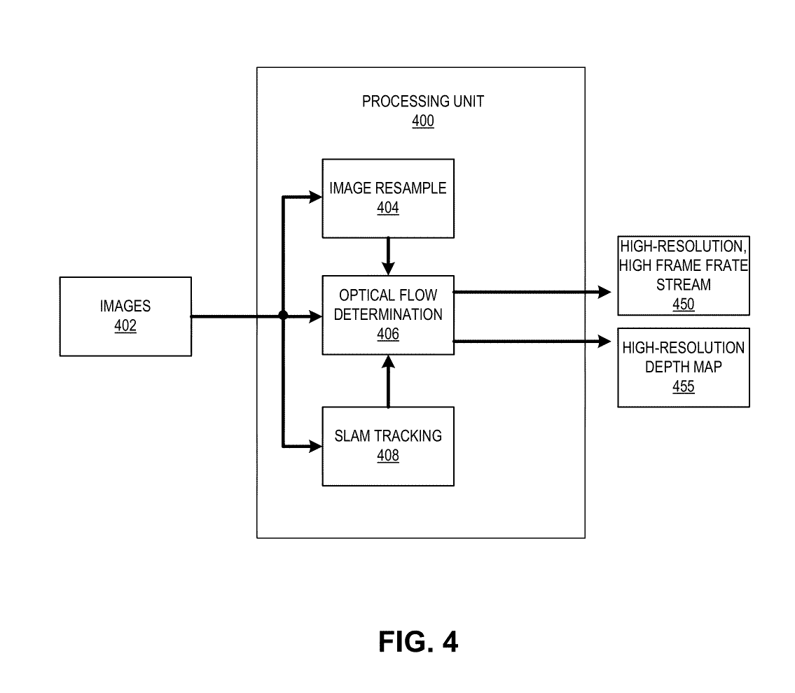

FIG. 4 is a functional block diagram of a processing unit 400 for optical flow computations, in one embodiment. In one embodiment, processing unit 400, under direction of program code, may perform processes 200 and/or 300, discussed above. For example, a temporal sequence of high-resolution, low frame rate images 402 may be received by the processing unit 400. The high-resolution, low frame rate images are provided to the optical flow determination module 406. The high-resolution images 402 are also provided to image resampling module 404 for optional subsampling. That is, resampling module 404 may down sample the high-resolution images 402, which are then provided to optical flow determination module 406. Also shown as included in processing unit 400 is a SLAM tracking module 408. In one embodiment, SLAM tracking module 408 provides camera tracking and a sparse point cloud based on the received images 402. Processing unit 400 is shown as generating a high-resolution, high frame rate output to be displayed to a user, and also a high-resolution depth map that may be used by an Augmented Reality (AR) engine (not shown) that perform any operations related to augmented reality based on camera pose.

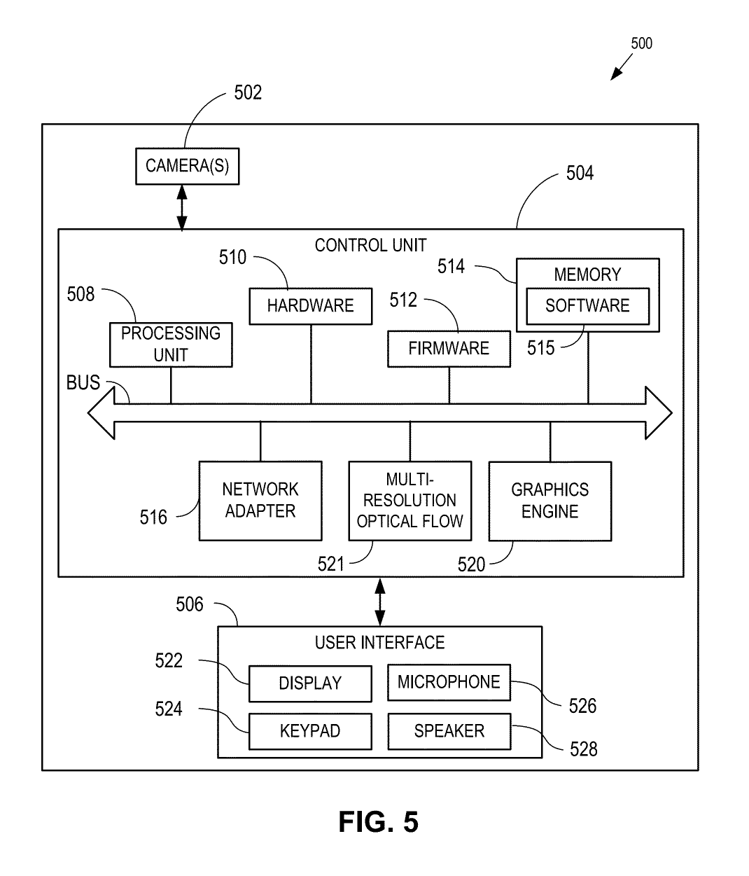

FIG. 5 is a functional block diagram of a mobile platform 500 capable of performing the processes discussed herein. For example, mobile platform 500 may be configured to perform the methods described in FIG. 2 and FIG. 3. As used herein, a mobile platform refers to a device such as a cellular or other wireless communication device, personal communication system (PCS) device, personal navigation device (PND), Personal Information Manager (PIM), Personal Digital Assistant (PDA), laptop, smart watch, wearable computer, or other suitable mobile platform which is capable of receiving wireless communication and/or navigation signals, such as navigation positioning signals. The term “mobile platform” is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile platform” is intended to include all devices, including wireless communication devices, computers, laptops, smart watches, etc. which are capable of communication with a server, such as via the Internet, WiFi, or other network, and regardless of whether satellite signal reception, assistance data reception, and/or position-related processing occurs at the device, at a server, or at another device associated with the network. In addition a “mobile platform” may also include all electronic devices which are capable of augmented reality (AR), virtual reality (VR), and/or mixed reality (MR) applications. Any operable combination of the above are also considered a “mobile platform.”

Mobile platform 500 may optionally include one or more cameras (e.g., camera 502) as well as an optional user interface 506 that includes the display 522 capable of displaying images captured by the camera 502. For example, mobile platform 500 may include a high-resolution camera with a relatively low frame rate as well as a lower resolution camera with a relatively high frame rate. In some embodiments, camera 502 is capable of switching between high-resolution images and high frame rate captures. For example, camera 502 may capture high-resolution still images while also capturing 30 or higher frames per second video having a lower resolution than the still images. In some embodiments, one or all cameras described herein (e.g., the high-resolution and low-resolution camera sources, if different) are located on a device other than mobile platform 500. For example, mobile platform 500 may receive camera data from one or more external cameras communicatively coupled to mobile platform 500.

User interface 506 may also include a keypad 524 or other input device through which the user can input information into the mobile platform 500. If desired, the keypad 524 may be obviated by integrating a virtual keypad into the display 522 with a touch sensor. User interface 506 may also include a microphone 526 and speaker 528.

Mobile platform 500 also includes a control unit 504 that is connected to and communicates with the camera 502 and user interface 506, if present. The control unit 504 accepts and processes images received from the camera 502 and/or from network adapter 516. Control unit 504 may be provided by a processing unit 508 and associated memory 514, hardware 510, software 515, and firmware 512. In one embodiment, Mobile platform 500 include a module or engine MROF 521 to perform the functionality of MROF described within this application.

Processing unit 400 of FIG. 4 is one possible implementation of processing unit 508 for optical flow computations, as discussed above. Control unit 504 may further include a graphics engine 520, which may be, e.g., a gaming engine, to render desired data in the display 522, if desired. Processing unit 508 and graphics engine 520 are illustrated separately for clarity, but may be a single unit and/or implemented in the processing unit 508 based on instructions in the software 515 which is run in the processing unit 508. Processing unit 508, as well as the graphics engine 520 can, but need not necessarily include, one or more microprocessors, embedded processors, controllers, application specific integrated circuits (ASICs), digital signal processors (DSPs), and the like. The terms processor and processing unit describes the functions implemented by the system rather than specific hardware. Moreover, as used herein the term “memory” refers to any type of computer storage medium, including long term, short term, or other memory associated with mobile platform 500, and is not to be limited to any particular type of memory or number of memories, or type of media upon which memory is stored.

The processes described herein may be implemented by various means depending upon the application. For example, these processes may be implemented in hardware 510, firmware 512, software 515, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the processes may be implemented with modules (e.g., procedures, functions, and so on) that perform the functions described herein. Any computer-readable medium tangibly embodying instructions may be used in implementing the processes described herein. For example, program code may be stored in memory 515 and executed by the processing unit 508. Memory may be implemented within or external to the processing unit 508.

If implemented in firmware and/or software, the functions may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, Flash Memory, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

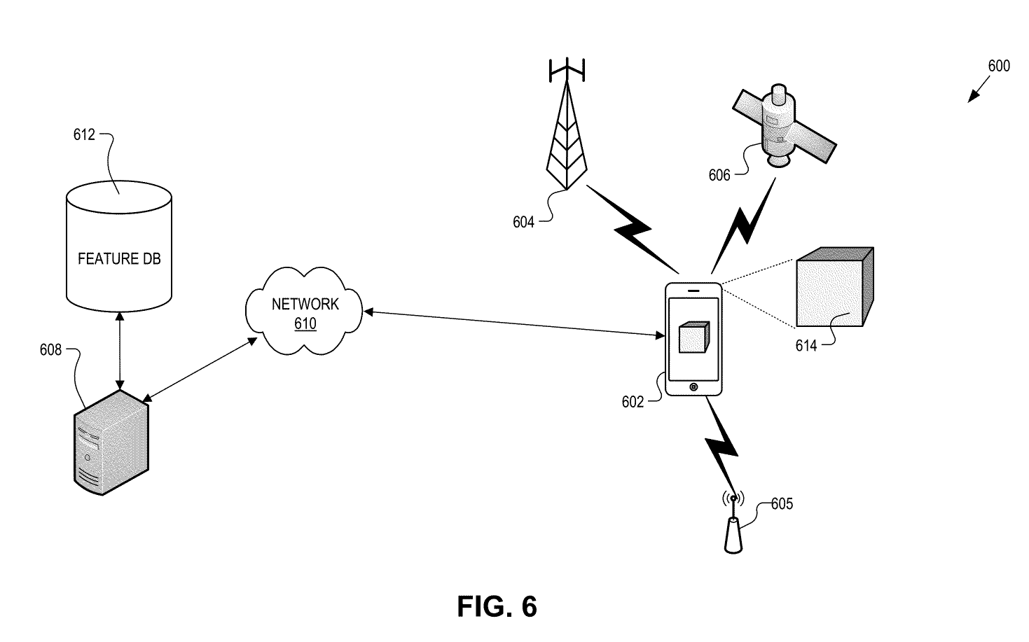

FIG. 6 is a functional block diagram of an image processing system 600. As shown, object recognition system 600 includes an example mobile platform 602 that includes a camera (not shown in current view) capable of capturing images of a scene including object 614. Feature database 612 may include data, including environment (online) and target (offline) map data.

The mobile platform 602 may include a display to show images captured by the camera and/or any up sampled images generated as a result of the processes discussed herein. The mobile platform 602 may also be used for navigation based on, e.g., determining its latitude and longitude using signals from a satellite positioning system (SPS), which includes satellite vehicle(s) 606, or any other appropriate source for determining position including cellular tower(s) 604 or wireless communication access points 705. The mobile platform 602 may also include orientation sensors, such as a digital compass, accelerometers or gyroscopes that can be used to determine the orientation of the mobile platform 602.

A satellite positioning system (SPS) typically includes a system of transmitters positioned to enable entities to determine their location on or above the Earth based, at least in part, on signals received from the transmitters. Such a transmitter typically transmits a signal marked with a repeating pseudo-random noise (PN) code of a set number of chips and may be located on ground based control stations, user equipment and/or space vehicles. In a particular example, such transmitters may be located on Earth orbiting satellite vehicles (SVs) 606. For example, a SV in a constellation of Global Navigation Satellite System (GNSS) such as Global Positioning System (GPS), Galileo, Glonass or Compass may transmit a signal marked with a PN code that is distinguishable from PN codes transmitted by other SVs in the constellation (e.g., using different PN codes for each satellite as in GPS or using the same code on different frequencies as in Glonass).

In accordance with certain aspects, the techniques presented herein are not restricted to global systems (e.g., GNSS) for SPS. For example, the techniques provided herein may be applied to or otherwise enabled for use in various regional systems, such as, e.g., Quasi-Zenith Satellite System (QZSS) over Japan, Indian Regional Navigational Satellite System (IRNSS) over India, Beidou over China, etc., and/or various augmentation systems (e.g., an Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein an SPS may include any combination of one or more global and/or regional navigation satellite systems and/or augmentation systems, and SPS signals may include SPS, SPS-like, and/or other signals associated with such one or more SPS.

The mobile platform 602 is not limited to use with an SPS for position determination, as position determination techniques may be implemented in conjunction with various wireless communication networks, including cellular towers 604 and from wireless communication access points 605, such as a wireless wide area network (WWAN), a wireless local area network (WLAN), a wireless personal area network (WPAN). Further the mobile platform 602 may access one or more servers 608 to obtain data, such as online and/or offline map data from a database 612, using various wireless communication networks via cellular towers 604 and from wireless communication access points 605, or using satellite vehicles 606 if desired. The term “network” and “system” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, Long Term Evolution (LTE), and so on. A CDMA network may implement one or more radio access technologies (RATs) such as cdma2000, Wideband-CDMA (W-CDMA), and so on. Cdma2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The techniques may also be implemented in conjunction with any combination of WWAN, WLAN and/or WPAN.

As shown in FIG. 6, system 600 includes mobile platform 602 capturing an image of object 614 to be detected and tracked based on the map data included in feature database 612. As illustrated, the mobile platform 602 may access a network 610, such as a wireless wide area network (WWAN), e.g., via cellular tower 604 or wireless communication access point 605, which is coupled to a server 608, which is connected to database 612 that stores information related to target objects and their images. While FIG. 6 shows one server 608, it should be understood that multiple servers may be used, as well as multiple databases 612. Mobile platform 602 may perform the object detection and tracking itself, as illustrated in FIG. 6, by obtaining at least a portion of the database 612 from server 608 and storing the downloaded map data in a local database inside the mobile platform 602. The portion of a database obtained from server 608 may be based on the mobile platform's geographic location as determined by the mobile platform's positioning system. Moreover, the portion of the database obtained from server 608 may depend upon the particular application that requires the database on the mobile platform 602. The mobile platform 602 may extract features from a captured query image, and match the query features to features that are stored in the local database. The query image may be an image in the preview frame from the camera or an image captured by the camera, or a frame extracted from a video sequence. The object detection may be based, at least in part, on determined confidence levels for each query feature, which can then be used in outlier removal. By downloading a small portion of the database 612 based on the mobile platform's geographic location and performing the object detection on the mobile platform 602, network latency issues may be avoided and the over the air (OTA) bandwidth usage is reduced along with memory requirements on the client (i.e., mobile platform) side. If desired, however, the object detection and tracking may be performed by the server 608 (or other server), where either the query image itself or the extracted features from the query image are provided to the server 608 by the mobile platform 602. In one embodiment, online map data is stored locally by mobile platform 602, while offline map data is stored in the cloud in database 612.

The order in which some or all of the process blocks appear in each process discussed above should not be deemed limiting. Rather, one of ordinary skill in the art having the benefit of the present disclosure will understand that some of the process blocks may be executed in a variety of orders not illustrated.

Those of skill would further appreciate that the various illustrative logical blocks, modules, engines, circuits, and algorithm steps described in connection with the embodiments disclosed herein may be implemented as electronic hardware, computer software, or combinations of both. To clearly illustrate this interchangeability of hardware and software, various illustrative components, blocks, modules, engines, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Various modifications to the embodiments disclosed herein will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A computer-implemented method for determining optical flow from a plurality of images, the method comprising:
receiving a first image frame from a first plurality of images, wherein the first plurality of images have a first resolution and a first frame rate;
receiving a second image frame from a second plurality of images, wherein the second plurality of images have a second resolution less than the first resolution and a second frame rate greater than the first frame rate;
computing a first optical flow from the first image frame to the second image frame; and
outputting, based at least in part on the first optical flow from the first image frame to the second image frame, a third image frame as part of an output stream, the output stream having a frame rate greater than or equal to the first frame rate, and wherein the third image frame has a resolution greater than or equal to the second resolution.

2. The computer-implemented method of claim 1, wherein the first plurality of images are received from a first camera sensor, and wherein the second plurality of images are received from a second camera sensor.

3. The computer-implemented method of claim 1, wherein the first plurality of images and the second plurality of images are received from a same camera sensor.

4. The computer-implemented method of claim 1, further comprising:
computing, in response to receiving a fourth and a fifth image frames having the second resolution, a second optical flow from the fourth image frame to the fifth image frame;
computing, in response to receiving a sixth image frame having the first resolution, a third optical flow from the fifth image frame to the sixth image frame; and
outputting, based at least in part on the third optical flow from the fifth image frame to the sixth image frame, a seventh image frame, the seventh image frame having a resolution greater than the second resolution.

5. The computer-implemented method of claim 1, further comprising:
outputting a depth map at the third resolution in response to the computed optical flows.

6. The computer-implemented method of claim 1, further comprising:
receiving a fourth and a fifth image frames having the second resolution; and
computing, based at least in part on a flow field from the first optical flow, a second optical flow from the fourth image frame to the fifth image frame.

7. The computer-implemented method of claim 1, further comprising:
blending a morphed fourth image with an up sampled version of the second image frame in response to determining an optical flow computation from the second image frame to a fourth image frame is unreliable, wherein the fourth image frame is from the first plurality of images having the first resolution.

8. A device for determining optical flow from a plurality of images, the device comprising:
memory adapted to store program code for determining optical flow from a plurality of images; and
at least one processing unit connected to the memory, wherein the program code is configured to cause the at least one processing unit to:
receive a first image frame from a first plurality of images, wherein the first plurality of images have a first resolution and a first frame rate;
receive a second image frame from a second plurality of images, wherein the second plurality of images have a second resolution less than the first resolution and a second frame rate greater than the first frame rate;
compute a first optical flow from the first image frame to the second image frame; and
output, based at least in part on the first optical flow from the first image frame to the second image frame, a third image frame as part of an output stream, the output stream having a frame rate greater than or equal to the first frame rate, and wherein the third image frame has a resolution greater than or equal to the second resolution.

9. The device of claim 8, wherein the first plurality of images are received from a first camera sensor, and wherein the second plurality of images are received from a second camera sensor.

10. The device of claim 8, wherein the first plurality of images and the second plurality of images are received from a same camera sensor.

11. The device of claim 8, further comprising instructions to:
compute, in response to receiving a fourth and a fifth image frames having the second resolution, a second optical flow from the fourth image frame to the fifth image frame;
compute, in response to receiving a sixth image frame having the first resolution, a third optical flow from the fifth image frame to the sixth image frame; and
output, based at least in part on the third optical flow from the fifth image frame to the sixth image frame, a seventh image frame, the seventh image frame having a resolution greater than the second resolution.

12. The device of claim 8, further comprising instructions to:
output a depth map at the third resolution in response to the computed optical flows.

13. The device of claim 8, further comprising instructions to:
receive a fourth and a fifth image frames having the second resolution; and
compute, based at least in part on a flow field from the first optical flow, a second optical flow from the fourth image frame to the fifth image frame.

14. The device of claim 8, further comprising:
blend a morphed fourth image with an up sampled version of the second image frame in response to determining an optical flow computation from the second image frame to a fourth image frame is unreliable, wherein the fourth image frame is from the first plurality of images having the first resolution.

15. A tangible non-transitory computer-readable medium including program code stored thereon for determining optical flow from a plurality of images, the program code comprising instructions to:
receive a first image frame from a first plurality of images, wherein the first plurality of images have a first resolution and a first frame rate;
receive a second image frame from a second plurality of images, wherein the second plurality of images have a second resolution less than the first resolution and a second frame rate greater than the first frame rate;
compute a first optical flow from the first image frame to the second image frame; and
output, based at least in part on the first optical flow from the first image frame to the second image frame, a third image frame as part of an output stream, the output stream having a frame rate greater than or equal to the first frame rate, and wherein the third image frame has a resolution greater than or equal to the second resolution.

16. The medium of claim 15, wherein the first plurality of images are received from a first camera sensor, and wherein the second plurality of images are received from a second camera sensor.

17. The medium of claim 15, wherein the first plurality of images and the second plurality of images are received from a same camera sensor.

18. The medium of claim 15, further comprising instructions to:
compute, in response to receiving a fourth and a fifth image frames having the second resolution, a second optical flow from the fourth image frame to the fifth image frame;
compute, in response to receiving a sixth image frame having the first resolution, a third optical flow from the fifth image frame to the sixth image frame; and
output, based at least in part on the third optical flow from the fifth image frame to the sixth image frame, a seventh image frame, the seventh image frame having a resolution greater than the second resolution.

19. The medium of claim 15, further comprising instructions to:
output a depth map at the third resolution in response to the computed optical flows.

20. The medium of claim 15, further comprising instructions to:
receive a fourth and a fifth image frames having the second resolution; and
compute, based at least in part on a flow field from the first optical flow, a second optical flow from the fourth image frame to the fifth image frame.

21. The medium of claim 15, further comprising instructions to:
blend a morphed fourth image with an up sampled version of the second image frame in response to determining an optical flow computation from the second image frame to a fourth image frame is unreliable, wherein the fourth image frame is from the first plurality of images having the first resolution.

22. An apparatus for determining optical flow from a plurality of images, the apparatus comprising:
means for receiving a first image frame from a first plurality of images, wherein the first plurality of images have a first resolution and a first frame rate;
means for receiving a second image frame from a second plurality of images, wherein the second plurality of images have a second resolution less than the first resolution and a second frame rate greater than the first frame rate;
means for computing a first optical flow from the first image frame to the second image frame; and
means for outputting, based at least in part on the first optical flow from the first image frame to the second image frame, a third image frame as part of an output stream, the output stream having a frame rate greater than or equal to the first frame rate, and wherein the third image frame has a resolution greater than or equal to the second resolution.

23. The apparatus of claim 22, wherein the first plurality of images are received from a first camera sensor, and wherein the second plurality of images are received from a second camera sensor.

24. The apparatus of claim 22, wherein the first plurality of images and the second plurality of images are received from a same camera sensor.

25. The apparatus of claim 22, further comprising:
means for computing, in response to receiving a fourth and a fifth image frames having the second resolution, a second optical flow from the fourth image frame to the fifth image frame;
means for computing, in response to receiving a sixth image frame having the first resolution, a third optical flow from the fifth image frame to the sixth image frame; and
means for outputting, based at least in part on the third optical flow from the fifth image frame to the sixth image frame, a seventh image frame, the seventh image frame having a resolution greater than the second resolution.

26. The apparatus of claim 22, further comprising:
means for outputting a depth map at the third resolution in response to the computed optical flows.

27. The apparatus of claim 22, further comprising:
means for receiving a fourth and a fifth image frames having the second resolution; and
means for computing, based at least in part on a flow field from the first optical flow, a second optical flow from the fourth image frame to the fifth image frame.

28. The apparatus of claim 22, further comprising:
means for blending a morphed fourth image with an up sampled version of the second image frame in response to determining an optical flow computation from the second image frame to a fourth image frame is unreliable, wherein the fourth image frame is from the first plurality of images having the first resolution.
